(19) United States
(12) Patent Application Publication
(10) Pub. No.: US 2024/0082999 A1
(43) Pub. Date: Mar. 14, 2024

(54) TECHNIQUE FOR TIGHTENING FASTENERS WITH ELECTRIC POWER TOOL

(71) Applicant: MAKITA CORPORATION, Anjo-shi (JP)

(72) Inventors: Yuta IZUTSU, Anjo-shi (JP); Hirokatsu YAMAMOTO, Anjo-shi (JP); Yusuke FURUYA, Anjo-shi (JP)

(73) Assignee: MAKITA CORPORATION, Anjo-shi (JP)

(21) Appl. No.: 18/241,691

(22) Filed: Sep. 1, 2023

(30) Foreign Application Priority Data
Sep. 14, 2022 (JP) 2022-146303

(51) Int. Cl. B25B 23/147; H02P 23/00

(52) U.S. Cl. CPC B25B 23/147; H02P 23/0077

(57) ABSTRACT

One aspect of the present disclosure provides an electric power tool including an output shaft, a motor, a manual switch, a memory device, a first circuit, and a second circuit distinct from the first circuit. The memory device stores two or more sets of job information. Each of the two or more sets of job information includes at least one operation setting of the motor for performing an associated tightening operation. The first circuit (i) receives one set of job information and (ii) drives the motor in accordance with the at least one operation setting included in the one set of job information based on the manual switch being or having been manually operated. The second circuit outputs a next set of job information from the memory device to the first circuit based on the first circuit having completed driving the motor.

### CROSS-REFERENCE TO RELATED APPLICATIONS

This application claims the benefit of Japanese Patent Application No. 2022-146303 filed on Sep. 14, 2022 with the Japan Patent Office, the entire disclosure of which is incorporated herein by reference.

### BACKGROUND

The present disclosure relates to an electric power tool.

Japanese Patent No. 6395081 (hereinafter referred to as '081 patent) discloses an operation management apparatus that manages tightening operations of screws by an electric power tool. This operation management apparatus transmits a desired value of tightening force from a smart terminal to the electric power tool every time the electric power tool performs a tightening operation.

The '081 patent also discloses that the smart terminal transmits two or more desired values of the tightening force to the electric power tool in a sequential manner in order for the electric power tool to perform two or more tightening operations successively.

In the '081 patent, the electric power tool stores the desired value received from the smart terminal. When a trigger switch of the electric power tool is pulled, a motor of the electric power tool is driven so that the tightening force reaches the desired value stored; and thereby a screw is tightened. The electric power tool also transmits a result of the tightening operation to the operation management apparatus via the smart terminal. In this manner, the operation management apparatus can manage the results of the tightening operations by the electric power tool while setting the operation of the electric power tool via the smart terminal.

### SUMMARY

In order for the aforementioned operation management apparatus to set the operation of the electric power tool, it is necessary for the electric power tool to communicate with the operation management apparatus in every tightening operation.

Thus, it is necessary that a communication is established between the electric power tool and the operation management apparatus in every tightening operation even in a case where the electric power tool repeatedly performs the same pattern of two or more of different tightening operations. As a result, inefficiencies such as excessive communication, excessive processing load, and excessive data storing may occur in both the electric power tool and the operation management apparatus.

In one aspect of the present disclosure, it is desirable to reduce the number of communications between an electric power tool and an external device during two or more tightening operations of fasteners.

In the present disclosure, languages such as “first” and “second” merely intend to distinguish one element from another. Such languages do not intend to limit the order or the number of elements. Accordingly, a first element may be referred to as a second element; and likewise, a second element may be referred to as a first element. In addition, a first element may be included without a second element; and likewise, a second element may be included without a first element.

One aspect of the present disclosure provides an electric power tool including an output shaft, a motor, a manual switch, a memory device, a first circuit, and a second circuit.

The output shaft (i) includes a tip tool or (ii) is configured to be detachably attached to the tip tool. The tip tool is configured to detachably engage with fasteners. The motor is configured to rotationally drive the output shaft. The manual switch is configured to be manually operated by a user of the electric power tool for driving the motor. The memory device is configured to store two or more sets of job information. The two or more sets of job information are associated with respective two or more tightening operations of the fasteners. Each of the two or more sets of job information includes at least one operation setting of the motor for performing an associated tightening operation. The first circuit is configured (i) to receive one set of job information and (ii) to drive the motor in accordance with the at least one operation setting included in the one set of job information based on the manual switch being or having been manually operated. The one set of job information corresponds to one of the two or more sets of job information stored in the memory device. The second circuit is (i) distinct from the first circuit and (ii) configured to output a next set of job information in the two or more sets of job information from the memory device to the first circuit based on the first circuit having completed driving the motor. The next set of job information is associated with a next tightening operation in the two or more tightening operations.

The electric power tool configured as above does not require to obtain the one set of job information from an external device in every tightening operation, which can reduce the number of communications between the electric power tool and the external device during the two or more tightening operations.

Another aspect of the present disclosure provides a method of tightening fasteners with an electric power tool, the method including:
storing two or more sets of job information in a memory device of the electric power tool, the two or more sets of job information being associated with respective two or more tightening operations of the fasteners, each of the two or more sets of job information including at least one operation setting of a motor of the electric power tool for performing an associated tightening operation; receiving one set of job information by a first circuit of the electric power tool, the one set of job information corresponding to one of the two or more sets of job information stored in the memory device, the first circuit being configured to drive the motor in accordance with the at least one operation setting included in the one set of job information received;
driving the motor by the first circuit based on a manual switch of the electric power tool being or having been manually operated; and
outputting a next set of job information in the two or more sets of job information from the memory device to the first circuit by a second circuit of the electric power tool based on the first circuit having completed driving the motor, the second circuit being distinct from the first circuit, the next set of job information being associated with a next tightening operation in the two or more tightening operations.

According to the method as mentioned above, the electric power tool does not require to obtain the one set of job information from an external device in every tightening operation, which can reduce the number of communications between the electric power tool and the external device during the two or more tightening operations.

### BRIEF DESCRIPTION OF THE DRAWINGS

An example embodiment of the present disclosure will be described hereinafter with reference to the accompanying drawings, in which:

FIG. 1 is a perspective view showing an external appearance of an electric power tool of a specific example embodiment;

FIG. 2 is a block diagram showing an electrical configuration of the electric power tool and an external terminal;

FIGS. 3A and 3B show respective examples of job information and sequence information:

FIG. 4 is a diagram showing a procedure to register a new set of sequence information from the external device to the electric power tool;

FIG. 5 is a flow chart showing a flow of an associated parameters initializing process;

FIG. 6 is a diagram showing an operation mode setting process;

FIG. 7 is a diagram showing a job termination process:

FIG. 8 is a flow chart showing a flow of a sequence update process; and

FIG. 9 is a schematic diagram showing one of variations.

### DETAILED DESCRIPTION OF EXEMPLARY EMBODIMENTS

### 1. Overview of Embodiments

One embodiment may provide an electric power tool including at least any one of:
Feature 1: an output shaft (i) including a tip tool or (ii) configured to be detachably attached to the tip tool;
Feature 2: the tip tool is configured to detachably engage with fasteners.
Feature 3: a motor configured to rotationally drive the output shaft;
Feature 4: a manual switch configured to be manually operated by a user of the electric power tool for driving the motor;
Feature 5: a memory device configured to store two or more sets of job information;
Feature 6: the two or more sets of job information are associated with respective two or more tightening operations (or fastening operations) of the fasteners;
Feature 7: each of the two or more sets of job information includes at least one operation setting of the motor for performing an associated tightening operation;
Feature 8: a first circuit (or a first circuitry) configured (i) to receive one set of job information and (ii) to drive the motor in accordance with the at least one operation setting included in the one set of job information based on (or in response to) the manual switch being or having been manually operated;
Feature 9: the one set of job information corresponds to one of the two or more sets of job information stored in the memory device;
Feature 10: a second circuit (or a second circuitry) distinct from the first circuit.
Feature 11: a second circuit (or a second circuitry) configured to output (or provide or deliver) a next set of job information in the two or more sets of job information from the memory device to the first circuit based on (or in response to) the first circuit having completed (or finished) driving the motor; and
Feature 12: the next set of job information is associated with a next tightening operation in the two or more tightening operations.

The electric power tool including at least the features 1 through 12 does not require to obtain the one set of job information from an external device in every tightening operation, which can reduce the frequency of communication or the number of communications between the electric power tool and the external device during the two or more tightening operations to thereby inhibit an increase in a processing load in the electric power tool and in the external device. This electric power tool can also inhibit an increase in the amount of job information stored in the memory device since it is not necessary to obtain and store the one set of job information in every communication with the external device.

One embodiment may include, in addition to or in place of at least one of the features 1 through 12, at least any one of:
Feature 13: the memory device is configured to store a set of sequence information;
Feature 14: the set of sequence information designates an order in which each of the two or more sets of job information is assigned to the next set of job information; and
Feature 15: the second circuit is configured to read out the next set of job information from the two or more sets of job information in the order designated by the set of sequence information stored in the memory device.

The electric power tool including at least the features 1 through 15 can perform the two or more tightening operations in the order designated by the set of sequence information.

One embodiment may include, in addition to or in place of at least any one of the features 1 through 15, at least any one of:
Feature 16: the set of sequence information includes two or more parameters associated with the respective two or more sets of job information;
Feature 17: each of the two or more parameters defines a specified number of times to output an associated set of job information; and
Feature 18: the second circuit is configured to output the next set of job information to the first circuit in every completion of a drive of the motor by the first circuit until the second circuit completes outputs of the next set of job information for the specified number of times defined by an associated parameter.

In the electric power tool including at least the features 1 through 18, since it is not necessary to repeatedly read out the same set of job information from the memory device, the processing load in the second circuit can be reduced.

One embodiment may include, in addition to or in place of at least any one of the features 1 through 18,
Feature 19: the second circuit is configured to read out the next set of job information from the two or more sets of job information in an order in which each of the two or more sets of job information is stored in the memory device.

In the electric power tool including at least the features 1 through 12 and 19, the two or more tightening operations can be performed in a desired order without the set of sequence information, if each of the two or more sets of job information is stored in the memory device in an order in which the associated tightening operation is performed.

One embodiment may include, in addition to or in place of at least any one of the features 1 through 19, at least any one of:
Feature 20: a sensor configured (i) to detect a result of a tightening operation performed and (ii) to output a detection signal;
Feature 21: the detection signal indicates the result of the tightening operation performed;
Feature 22: the first circuit is configured to receive the detection signal;
Feature 23: the first circuit is configured to output, to the second circuit, the result indicated by the detection signal based on (or in response to) a completion of a drive of the motor;
Feature 24: the second circuit is configured to receive the result; and
Feature 25: the second circuit is configured to store the result in the memory device.

The electric power tool including at least the features 1 through 12, and 20 through 25 does not need to transmit the result from the electric power tool to an operation management apparatus in every tightening operation. Accordingly, the frequency of communication between the electric power tool and the operation management apparatus can be reduced. The result stored in the memory device is output to the operation management apparatus in accordance with a request from the operation management apparatus and is managed in the operation management apparatus.

One embodiment may include, in addition to or in place of at least any one of the features 1 through 25,
Feature 26: the at least one operation setting includes a desired rotational speed (or a target rotational speed) of the motor, a desired tightening torque (or a target tightening torque) of a fastener, a desired operating time (or a target operating time) of the motor, a start-up profile of the motor, and/or a stop profile of the motor.

In the electric power tool including at least the features 1 through 12 and 26, the motor can be driven in accordance with the desired rotational speed, the desired tightening torque, the desired operating time, the start-up profile, and/or the stop profile corresponding to the tightening operation being performed.

One embodiment may include, in addition to or in place of at least any one of the features 1 through 26, at least any one of:
Feature 27: a first regulator associated with the first circuit; and
Feature 28: a second regulator associated with the second circuit.

One embodiment may include, in addition to or in place of at least any one of the features 1 through 28, at least any one of:
Feature 29: the first regulator is configured to generate a first voltage;
Feature 30: the second regulator is configured to receive the first voltage from the first regulator; and
Feature 31: the second regulator is configured to generate a second voltage based on the first voltage.

One embodiment may include, in addition to or in place of at least any one of the features 1 through 31, at least any one of:
Feature 32: the first regulator is configured to receive an electric power from a battery pack: and
Feature 33: the first regulator is configured to generate the first voltage based on the electric power.

One embodiment may include, in addition to or in place of at least any one of the features 1 through 33,
Feature 34: the second voltage is different from the first voltage.

One embodiment may include, in addition to or in place of at least any one of the features 1 through 34, at least any one of:
Feature 35: a first circuit board including the first circuit thereon;
Feature 36: a second circuit board including the second circuit thereon; and
Feature 37: a second circuit board distinct from the first circuit board.

One embodiment may include, in addition to or in place of at least any one of the features 1 through 37,
Feature 38: a connector electrically coupling the first circuit board to the second circuit board.

One embodiment may include, in addition to or in place of at least any one of the features 1 through 38,
Feature 39: the memory device is on the second circuit board.

One embodiment may include, in addition to or in place of at least any one of the features 1 through 39,
Feature 40: the memory device includes a rewritable and non-volatile memory.

Examples of the rewritable and non-volatile memory include an Electrically Erasable Programmable Read-Only Memory (EEPROM), a flash memory, a Resistive Random Access Memory (ReRAM), and a Ferroelectric Random Access Memory (FeRAM).

In one embodiment, the memory device may include a volatile memory in addition to or in place of the rewritable and non-volatile memory.

One embodiment may include, in addition to or in place of at least any one of the features 1 through 40, at least any one of:
Feature 41: a communicator configured to perform a wired communication or a wireless communication with an external device;
Feature 42: the external device is distinct from the electric power tool; and
Feature 43: the second circuit is configured (i) to receive the two or more sets of job information from the external device via the communicator and (ii) to store, in the memory device, the two or more sets of job information received.

One embodiment may include, in addition to or in place of at least any one of the features 1 through 43,
Feature 44: the second circuit includes the communicator.

One embodiment may include, in addition to or in place of at least any one of the features 1 through 44,
Feature 45: the second circuit includes the memory device.

One embodiment may include, in addition to or in place of at least any one of the features 1 through 45,
Feature 46: a main body including the motor, the manual switch, the memory device, the first circuit, and the second circuit.

In one embodiment, each of or one of the first circuit and the second circuit may include a microcomputer (or a microcontroller, or a microprocessor), a hard-wired logic, an application-specific integrated circuit (ASIC), an application-specific standard product (ASSP), a programmable logic device (such as a field programmable gate array (FPGA)), a discrete electronic component, and/or a combination of the above.

Examples of the electric power tool includes a fastening power tool configured to rotate the fasteners. Examples of the fastening power tool include an angled screwdriver, an angled impact driver, an electric driver, an impact driver, and an electric wrench. Examples of the fastener include a threaded fastener having a male thread or a female thread. Examples of the threaded fastener include a screw, a threaded nail, a bolt, and a nut.

The electric power tool may be in the form of a corded electric power tool configured to receive an electric power from an external power source, such as the AC mains, via a power cord.

Alternatively, the electric power tool may be in the form of a battery-powered electric power tool (or a cordless electric power tool). In this case, a battery may be attached to the electric power tool.

Examples of the motor include a brushed DC motor, a brushless DC motor, an AC motor, and a stepper motor.

One embodiment may provide a method including at least any one of:
Feature 47: storing two or more sets of job information in a memory device of the electric power tool;
Feature 48: the two or more sets of job information are associated with respective two or more tightening operations of fasteners;
Feature 49: each of the two or more sets of job information includes at least one operation setting of the motor of the electric power tool for performing an associated tightening operation;
Feature 50: receiving one set of job information by a first circuit of the electric power tool;
Feature 51: the one set of job information corresponds to one of the two or more sets of job information stored in the memory device;
Feature 52: the first circuit is configured to drive the motor in accordance with the at least one operation setting included in the one set of job information received;
Feature 53: driving the motor by the first circuit based on (or in response to) a manual switch of the electric power tool being or having been manually operated;
Feature 54: outputting a next set of job information in the two or more sets of job information from the memory device to the first circuit by a second circuit of the electric power tool based on (or in response to) the first circuit having completed driving the motor;
Feature 55: the second circuit is distinct from the first circuit; and
Feature 56: the next set of job information is associated with a next tightening operation in the two or more tightening operations.

According to a method including at least the Features 47 through 56, the electric power tool does not require to obtain the one set of job information from an external device in every tightening operation, which can reduce the frequency of communication or the number of communications between the electric power tool and the external device during the two or more tightening operations to thereby inhibit an increase in a processing load in the electric power tool and in the external device. This method can also inhibit an increase in the amount of job information stored in the memory device since it is not necessary for the electric power tool to obtain and store the one set of job information in every communication between the electric power tool and the external device.

In one embodiment, the Features 1 through 56 may be combined in any manner.

In one embodiment, any one of the Features 1 through 56 may be excluded.

### 2. Specific Example Embodiment

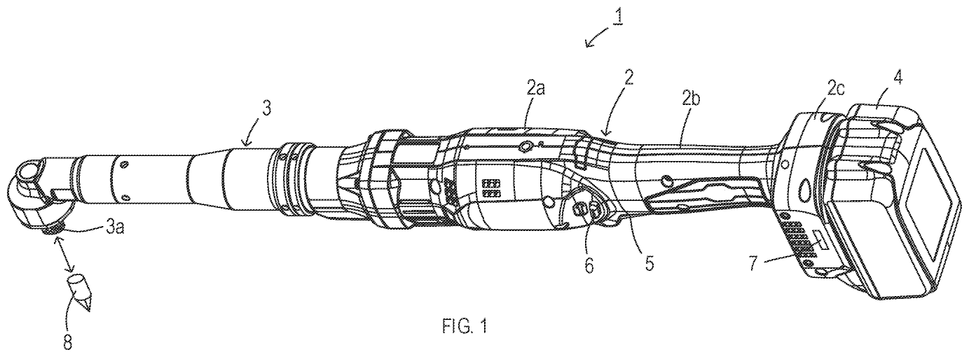

An electric power tool 1 shown in FIG. 1 is provided in the following example embodiment.

2.1 Mechanical Configuration

As shown in FIG. 1, the electric power tool 1 of the present embodiment is in the form of a battery-powered angled screwdriver. The electric power tool 1 is configured to rotate an unillustrated fastener, such as a screw, a threaded nail, a bolt, and a nut, and to tighten (or fasten) this fastener to an unillustrated workpiece.

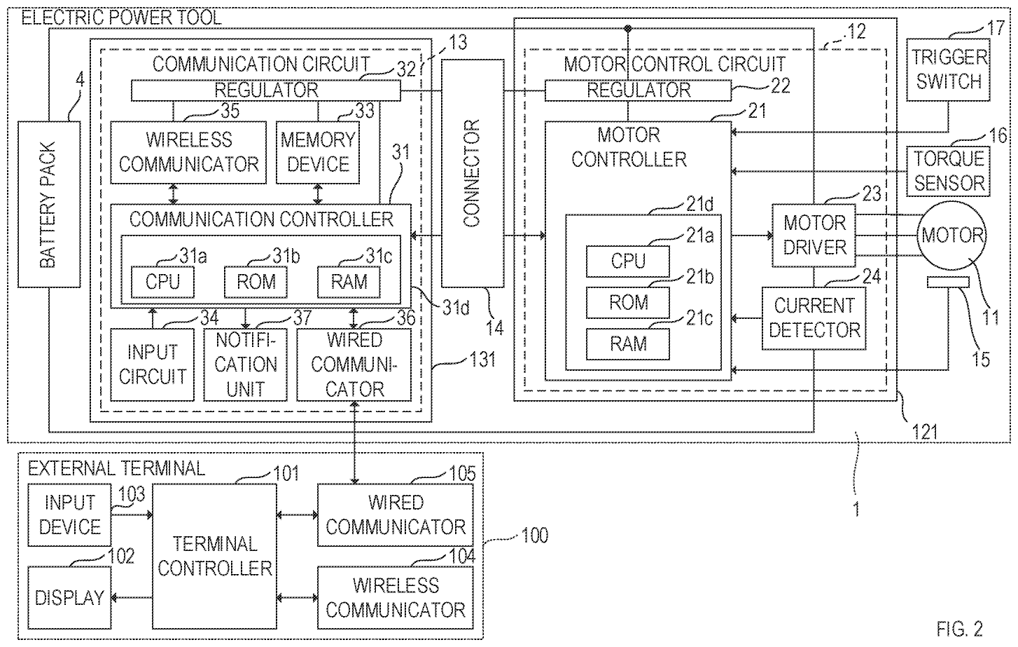

More specifically, the electric power tool 1 includes a main body 2. In the present embodiment, the main body 2 is a hollow cylinder. The main body 2 includes a motor housing 2a at a first end of the main body 2 along its longitudinal direction. The motor housing 2a houses a motor 11 (see FIG. 2) inside thereof.

The main body 2 includes a grip 2b between the first end and a second end of the main body 2 along its longitudinal direction. The grip 2b is configured to be held by a user of the electric power tool 1. The thickness of the grip 2b of the present embodiment is less than the thickness of the first end and the second end of the main body 2, which makes it easier for the user to hold the grip 2b.

The grip 2b includes a trigger 5 for driving the motor 11 in the vicinity of the motor housing 2a. The trigger 5 is configured to be pulled by the user while the user is holding the grip 2b.

The grip 2b includes a rotational direction switch 6 in the vicinity of the trigger 5. The rotational direction switch 6 is manipulated by the user to set the rotational direction of the motor 11 either to a forward direction or to a backward direction.

The main body 2 includes a battery port 2c at the second end of the main body 2. The battery port 2c is configured to mechanically and electrically engage with a battery pack 4 in a detachable manner. The battery port 2c includes a communication connector 7. The communication connector 7 is configured to be detachably coupled to an unillustrated electrical cable for communicating with an external terminal such as a personal computer. Examples of such an electrical cable include a Universal Serial Bus (USB) cable.

The electric power tool 1 includes an angled head 3 that is detachably attached to the first end of the main body 2. The angled head 3 includes an output shaft 3a at a leading end of the angled head 3 that is opposite the first end of the main body 2. The output shaft 3a extends orthogonally to an unillustrated rotational shaft of the motor 11. The angled head 3 includes an unillustrated gear mechanism inside the angled head 3. The driving force of the motor 11 is transmitted to the output shaft 3a via the gear mechanism to thereby rotationally drive the output shaft 3a. The output shaft 3a includes a tip portion configured such that a tip tool 8 is detachably attached to the tip portion. The tip tool 8 is configured to detachably engage with fasteners. Examples of the tip tool 8 include any type of tool bits for tightening (or fastening) the fasteners, more specifically, a driver bit, a wrench bit, a socket bit, and a nut-setter. In another embodiment, the tip portion of the output shaft 3a may include a tip tool that is not detachable from the tip portion.

2.2 Electrical Configuration

As shown in FIG. 2, the electric power tool 1 includes a motor control circuit 12. The motor control circuit 12 in the present embodiment is on a first circuit board 121 in the main body 2.

The motor control circuit 12 includes a motor controller 21. The motor controller 21 in the present embodiment includes a first microcomputer 21d including a first CPU 21a, a first ROM 21b, and a first RAM 21c. Functions of the first microcomputer 21d are achieved by the first CPU21a executing a program(s) stored in the first ROM 21b. When the first CPU21a executes the program(s), a method corresponding to the program(s) is performed.

In another embodiment, the motor controller 21 may include an additional microcomputer. In yet another embodiment, a part of or all of the functions achieved by the first CPU21a may be achieved by one or more electronic components (such as an integrated circuit). In yet another embodiment, the motor controller 21 may be in the form of a logic circuit (or a wired logic connection) including two or more electronic components. In yet another embodiment, the motor controller 21 may include an ASIC and/or an ASSP. In yet another embodiment, the motor controller 21 may include a programmable logic device in which reconfigurable logic circuits can be built. Examples of the programmable logic device include an FPGA.

The motor control circuit 12 includes a first regulator 22. The first regulator 22 (i) receives an electric power from the battery pack 4 and (ii) generates a first power supply voltage (for example, 5.0 Volts) for operating the motor controller 21. The motor controller 21 receives the first power supply voltage from the first regulator 22 to operate.

The motor control circuit 12 includes a motor driver 23. The motor driver 23 (i) receives the electric power from the battery pack 4 and (ii) delivers electric current to unillustrated phase windings of the motor 11 in accordance with a command from the motor controller 21. The motor 11 in the present embodiment is, but not limited to, a three-phase brushless DC motor. The motor driver 23 in the present embodiment is, but not limited to, a three-phase full-bridge circuit including unillustrated six switch devices.

The motor control circuit 12 includes an electric current detector 24. The electric current detector 24 (i) detects the magnitude of the electric current flowing through the motor 11 and (ii) outputs an electric current detection signal to the motor controller 21. The electric current detection signal indicates the magnitude of the electric current detected.

The electric power tool 1 includes a communication circuit 13. In the present embodiment, the communication circuit 13 is on a second circuit board 131 (i) in the main body 2 and (ii) distinct from the first circuit board 121.

The communication circuit 13 includes a communication controller 31. In the present embodiment, the communication controller 31 includes a second microcomputer 31d including a second CPU 31a, a second ROM 31b, and a second RAM31c. Functions of the second microcomputer 31d is achieved by the second CPU 31a executing a program(s) stored in the second ROM 31b. When the second CPU 31a executes the program(s), a method corresponding to the program(s) is performed.

In another embodiment, the communication controller 31 may include an additional microcomputer. In yet another embodiment, a part of or all of the functions achieved by the second CPU 31a may be achieved by one or more electronic components (such as an integrated circuit). In yet another embodiment, the communication controller 31 may be in the form of a logic circuit (or a wired logic connection) including two or more electronic components. In yet another embodiment, the communication controller 31 may include an ASIC and/or an ASSP. In yet another embodiment, the communication controller 31 may include a programmable logic device in which reconfigurable logic circuits can be built. Examples of the programmable logic device include an FPGA.

The communication circuit 13 includes a memory device 33. The memory device 33 in the present embodiment is in the form of a rewritable and non-volatile memory. More specifically, the memory device 33 may be in the form of an EEPROM, a flash memory, a ReRAM, or an FeRAM. Thus, the memory device 33 in the present embodiment (i) rewritably stores data and (ii) retains the stored data without a supply of an electric power. In another embodiment, the memory device 33 may be in the form of a volatile memory (for example, a RAM).

The communication circuit 13 includes an input circuit 34. The input circuit 34 receives an input by a user via an unillustrated manual switch. This input causes an operation setting (for example, the desired rotational speed and the desired tightening torque) of the motor 11 to be selected from two or more sets of job information stored in the memory device 33.

The communication circuit 13 includes a first wireless communicator 35. The first wireless communicator 35 wirelessly sends and receives data between the first wireless communicator 35 and an external terminal 100, which will be mentioned later, in accordance with a short-range wireless communication protocol. Examples of the short-range wireless communication protocol include Near Field Communication (NFC), Wi-Fi (registered trademark), Bluetooth (registered trademark), Bluetooth Low Energy (BLE: registered trademark), and Zigbee (registered trademark).

The communication circuit 13 includes a first wired communicator 36. The first wired communicator 36 sends and receives data between the first wired communicator 36 and the external terminal 100 via the electrical cable coupled to the communication connector 7.

The communication circuit 13 includes a notification unit 37. The notification unit 37 notifies the user of the status of the electric power tool 1, such as its operation mode engaged. In the present embodiment, the notification unit 37 includes at least one light-emitting diode (LED), which is not illustrated in the figures. The at least one LED is used to notify the user of the status of the electric power tool 1.

The communication circuit 13 includes a second regulator 32. The second regulator 32 (i) receives the first power supply voltage from the first regulator 22 and (ii) generates a second power supply voltage (for example, 3.3 Volts) for operating the communication circuit 13. The communication controller 31, the memory device 33, and the first wireless communicator 35 receive the second power supply voltage from the second regulator 32 to operate. The input circuit 34, the first wired communicator 36, and the notification unit 37 receive an electric power from the second regulator 32 via the communication controller 31 to operate.

The electric power tool 1 includes a connector 14 in the main body 2. The connector 14 electrically couples the first circuit board 121 (or the motor control circuit 12) to the second circuit board 131 (or the communication circuit 13). The connector 14 transmits (i) the first power supply voltage from the first regulator 22 to the second regulator 32 and (ii) data between the motor controller 21 and the communication controller 31.

The electric power tool 1 includes a rotation sensor 15 in the motor housing 2a. The rotation sensor 15 (i) detects a rotational position and a rotational frequency (or a rotational speed) of the motor 11 and (ii) outputs a rotation detection signal to the motor controller 21. The rotation detection signal indicates the detected rotational position and the detected rotational frequency.

The electric power tool 1 includes a torque sensor 16. The torque sensor 16 is disposed between the motor 11 and the output shaft 3a in the angled head 3. The torque sensor 16 (i) detects the magnitude of the tightening torque applied to the output shaft 3a and (ii) outputs a torque detection signal to the motor controller 21. The torque detection signal indicates the magnitude of the tightening torque detected.

The electric power tool 1 includes a trigger switch 17 in the main body 2. The trigger switch 17 is configured (i) to be turned ON in response to the trigger 5 being pulled and (ii) to be turned OFF in response to the trigger 5 being released.

Examples of the external terminal 100 include a personal computer, a smart phone, and a tablet computer. The external terminal 100 may be a terminal dedicated for the electric power tool 1.

The external terminal 100 includes a display 102. The display 102 displays letters, characters, and images thereon.

The external terminal 100 includes an input device 103. The input device 103 receives an input by the user. Examples of the input device 103 include a keyboard, a mouse, and a touch panel. The user sets, via the input device 103, (i) the operation modes of the electric power tool 1 and (ii) the two or more sets of job information.

The external terminal 100 includes a second wireless communicator 104. The second wireless communicator 104 wirelessly sends and receives data between the second wireless communicator 104 and the first wireless communicator 35 of the electric power tool 1 in accordance with the aforementioned short-range wireless communication protocol.

The external terminal 100 includes a second wired communicator 105. The second wired communicator 105 sends and receives data between the second wired communicator 105 and the first wired communicator 36 of the electric power tool 1 via the electrical cable coupled to the communication connector 7 of the electric power tool 1.

The external terminal 100 includes a terminal controller 101. The terminal controller 101 executes various processes based on inputs from the input device 103, the second wireless communicator 104, and the second wired communicator 105. The terminal controller 101 displays information on the display 102. The terminal controller 101 sends and receives data between the terminal controller 101 and the communication controller 31 of the electric power tool 1 via the second wireless communicator 104 and/or the second wired communicator 105.

The two or more sets of job information are associated with respective two or more tightening operations of the fasteners. Each of the two or more sets of job information includes at least one operation setting of the motor 11 for performing an associated tightening operation. The at least one operation setting includes the desired rotational speed of the motor 11, the desired tightening torque of a fastener, a desired operating time of the motor 11, a start-up profile of the motor 11, and/or a stop profile of the motor 11.

The desired operating time corresponds to a desired time period (in seconds) from the start-up of the motor 11 to the stop of the motor 11. The start-up profile is set to achieve a so-called soft start of the motor 11. More specifically, the start-up profile is set to gradually increase the rotational speed of the motor 11 to reach the desired rotational speed after the start-up of the motor 11. The stop profile is set to gradually reduce the rotational speed of the motor 11 to stop the motor 11 after the tightening torque applied to a fastener has reached the desired tightening torque.

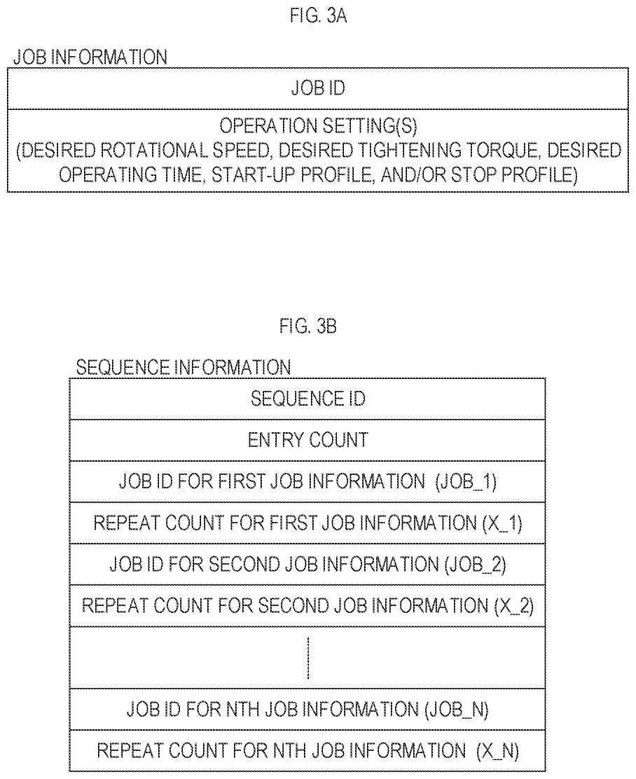

The terminal controller 101 generates the two or more sets of job information based on the input of the user received via the input device 103. Each of the two or more sets of job information is given its identifier (hereinafter referred to as JOB ID) as shown in FIG. 3A and transmitted to the electric power tool 1 via the second wireless communicator 104 or the second wired communicator 105.

In the electric power tool 1, the communication controller 31 (i) receives the two or more sets of job information via the first wireless communicator 35 or the first wired communicator 36, and (ii) stores the two or more sets of job information in the memory device 33 along with the respective JOB IDs.

2.3. Operation Modes of Electric Power Tool

The operation modes of the electric power tool 1 that can be set via the input device 103 includes a manual mode, a full-automatic mode, and a semi-automatic mode.

2.3.1. Manual Mode

In the manual mode, the communication controller 31 outputs, to the motor controller 21, one set of job information, selected by the user via the input circuit 34 from the two or more sets of job information stored in the memory device 33.

Every time the trigger 5 of the electric power tool 1 is pulled by the user, the motor controller 21 drives the motor 11 in accordance with the at least one operation setting included in the one set of job information received from the communication controller 31. Thus, the user can perform the tightening operation in accordance with the selected one set of job information by pulling the trigger 5.

2.3.2. Full-Automatic Mode

In the full-automatic mode, the terminal controller 101 of the external terminal 100 indicates the communication controller 31 the first set of job information in the two or more job information stored in the memory device 33 in accordance with a preset program. The communication controller 31 (i) selects the first set of job information indicated by the terminal controller 101 from the two or more sets of job information stored in the memory device 33 and (ii) outputs the first set of job information to the motor controller 21.

When the trigger 5 is pulled by the user, the motor controller 21 drives the motor 11 in accordance with the at least one operation setting included in the first set of job information and the first tightening operation is performed. When the drive of the motor 11 by the motor controller 21 is completed, the communication controller 31 transmits a tightening completion signal to the terminal controller 101.

Upon a receipt of the tightening completion signal, the terminal controller 101 indicates the communication controller 31 the second set of job information in the two or more sets of job information stored in the memory device 33 in accordance with the preset program, and the second tightening operation is performed by the electric power tool 1 as mentioned above. The second set of job information may be the same as or different from the first set of job information.

When the drive of the motor 11 based on the second set of job information is completed, the communication controller 31 transmits the tightening completion signal to the terminal controller 101. Upon a receipt of the tightening completion signal, the terminal controller 101 indicates the communication controller 31 the third set of job information in the two or more sets of job information stored in the memory device 33 in accordance with the preset program, and the third tightening operation is performed by the electric power tool 1 as mentioned above. The third set of job information may be the same as the first set of job information and/or the second set of job information. Alternatively, the third set of job information may be different from both the first set of job information and the second set of job information.

In summary, two or more tightening operations of the fasteners are sequentially performed by the electric power tool 1 under the management of the external terminal 100 in the full-automatic mode.

2.3.3. Semi-Automatic Mode

In the semi-automatic mode, the communication controller 31 (i) selects one set of job information from the two or more sets of job information in the memory device 33 in a preset order and (ii) outputs the selected one set of job information to the motor controller 21. In response to the user pulling the trigger 5, the motor controller 21 drives the motor 11 in accordance with the at least one operation setting included in the one set of job information received from the communication controller 31.

The memory device 33 also stores two or more sets of sequence information. Each of the two or more sets of sequence information defines the order by which the communication controller 31 selects each of the two or more sets of job information. Each of the two or more sets of sequence information in the present embodiment defines the order by which each of N sets of job information is selected (N being a natural number greater than or equal to 2).

More specifically, as shown in FIG. 3B, each of the two or more sets of sequence information in the present embodiment includes an entry count Cent, N JOB IDs (i.e. JOB_1 through JOB_N), and N repeat counts X_1 through X_N. The entry count Cent corresponds to the number of N sets of job information to be selected. Each of the N JOB IDs is associated with one set of job information in the two or more sets of job information stored in the memory device 33, as mentioned above. Each of the N JOB IDs in the present embodiment is arranged in the order by which the associated one set of job information is to be selected. The N repeat counts X_1 through X_N are associated with the respective N JOB IDs. Each of the N repeat counts X_1 through X_N defines a specified number of times to output one set of job information associated with the corresponding JOB ID.

Likewise the two or more sets of job information, the two or more sets of sequence information are generated in the terminal controller 101 of the external terminal 100 in accordance with a command from the input device 103. As shown in FIG. 3B, the two or more sets of sequence information thus generated are transmitted from the external terminal 100 to the electric power tool 1 along with their identifiers (hereinafter referred to as SEQUENCE ID) via the second wireless communicator 104 or the second wired communicator 105.

In the electric power tool 1, the communication controller 31 receives the two or more sets of sequence information via the first wireless communicator 35 or the first wired communicator 36 and stores them in the memory device 33. In the semi-automatic mode, any one of the two or more sets of sequence information is selected to be used. Thus, the two or more sets of sequence information are stored in the memory device 33 along with their respective SEQUENCE IDs.

Every time the trigger 5 is pulled by the user, the motor controller 21 drives the motor 11 in accordance with the at least one operation setting included in one set of job information (for example, JOB_1, JOB_2 . . . or JOB_N) selected by the communication controller 31. The two or more desired tightening operations thus can be sequentially performed by the motor 11 driven with the drive characteristics automatically changed, every time the user pulls the trigger 5.

In the present embodiment, after selecting all of the two or more sets of job information (for example, all of JOB_1 to JOB_N) included in one of the two or more sets of sequence information, the communication controller 31 returns to the selection of the first set of job information (in other words. JOB_1), and once again selects each of the two or more sets of job information in the same order. The user can thus repeatedly perform a sequence of (or a series of) tightening operations to tighten two or more fasteners based on the two or more sets of job information. In another embodiment, the two or more sets of sequence information may be used for an additional operation mode distinct from the semi-automatic mode. In the additional operation mode, the electric power tool 1 may perform a sequence of tightening operations once, based on the two or more sets of job information.

2.4. Exemplary Registration Procedure

A procedure to register a new set of sequence information from the external terminal 100 to the electric power tool 1 will be explained.

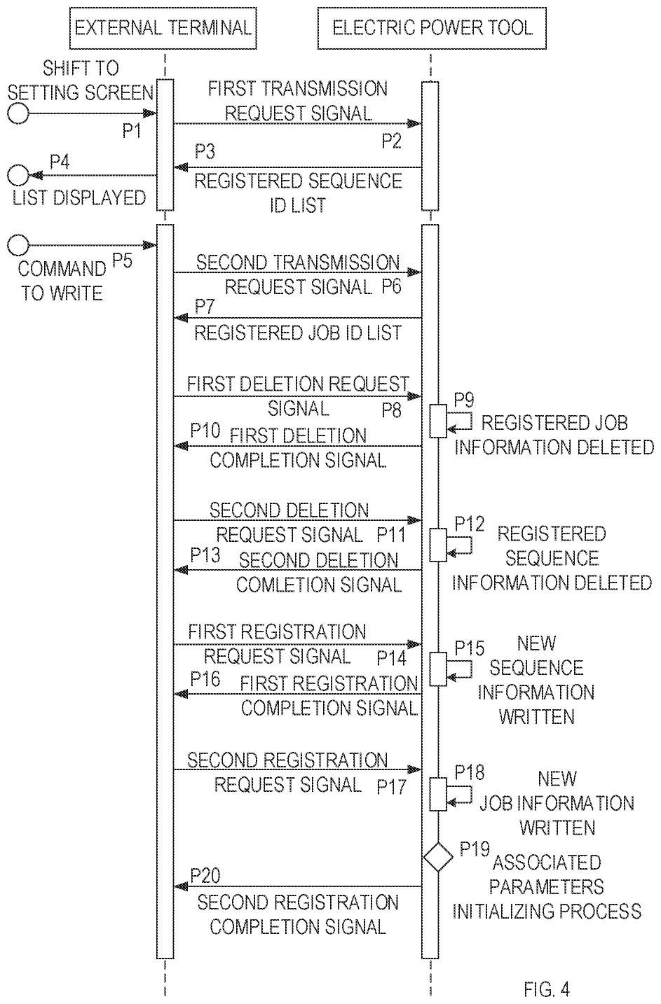

As shown in FIG. 4, in the first step, the user inputs a command to the terminal controller 101 of the external terminal 100 via the input device 103 of the external terminal 100 to change the screen of the display 102 to a setting screen for setting the new set of sequence information (P1). P stands for process.

After the screen is changed to the setting screen, the terminal controller 101 transmits a first transmission request signal for registered SEQUENCE IDs to the communication controller 31 of the electric power tool 1 (P2). In response to receiving the first transmission request signal, the communication controller 31 transmits, to the terminal controller 101, a list of two or more SEQUENCE IDs associated with the two or more sets of sequence information (hereinafter referred to as registered SEQUENCE ID list) stored in the memory device 33 (P3).

In response to obtaining the registered SEQUENCE ID list, the terminal controller 101 outputs the registered SEQUENCE ID list on the display 102 (P4). The user is thus able to identify the two or more sets of sequence information currently registered to the electric power tool 1 from the registered SEQUENCE ID list shown on the display 102.

If the user desires to change at least one of the two or more sets of sequence information currently registered, the user generates the new set of sequence information with the input device 103 and inputs a command to the terminal controller 101 via the input device 103 (for example, by pressing an enter button of the input device 103) to write the new set of sequence information (P5).

In response to this command, the terminal controller 101 transmits a second transmission request signal for registered JOB IDs to the communication controller 31 (P6). In response to receiving the second transmission request signal, the communication controller 31 transmits, to the terminal controller 101, a list of two or more JOB IDs associated with the two or more sets of job information (hereinafter referred to as registered JOB ID list) stored in the memory device 33 (P7).

In response to receiving the registered JOB ID list, the terminal controller 101 extracts, from the registered JOB ID list, one or more JOB IDs associated with one or more sets of registered job information that are not necessary in the registration of the new set of sequence information. The terminal controller 101 then transmits a first deletion request signal to the communication controller 31 (P8). The first deletion request signal specifies the one or more JOB IDs extracted.

In response to receiving the first deletion request signal, the communication controller 31 deletes, from the memory device 33, one or more sets of registered job information associated with the one or more JOB IDs extracted (P9) and transmits a first deletion completion signal to the terminal controller 101 (P10).

The user is thus able to visually recognize, on the external terminal 100 as necessary, that the one or more sets of registered job information are deleted from the electric power tool 1.

In response to receiving the first deletion completion signal, the terminal controller 101 transmits a second deletion request signal to the communication controller 31 (P11).

In response to receiving the second deletion request signal, the communication controller 31 deletes, from the memory device 33, one or more sets of registered sequence information that are not necessary in the registration of the new set of sequence information (P12). The communication controller 31 then transmits a second deletion completion signal to the terminal controller 101 (P13). The second deletion completion signal specifies one or more SEQUENCE IDs associated with the one or more sets of sequence information deleted.

The user is thus able to visually recognize, on the external terminal 100 as necessary, that the one or more sets of registered sequence information are deleted from the electric power tool 1.

The terminal controller 101 then transmits a first registration request signal to the communication controller 31 along with the new set of sequence information (P14). In response to receiving the first registration request signal, the communication controller 31 writes the new set of sequence information in the memory device 33 (P15) and transmits a first registration completion signal to the terminal controller 101 (P16).

The user is thus able to visually recognize, on the external terminal 100, that the new set of sequence information is registered in the electric power tool 1.

In response to receiving the first registration completion signal, the terminal controller 101 transmits a second registration request signal to the communication controller 31 along with one or more new sets of job information (P17). The second registration request signal requests the communication controller 31 to store, to the memory device 33, the one or more new sets of job information that are not yet stored in the memory device 33 among the two or more sets of job information defined by the new set of sequence information.

In response to receiving the second registration request signal, the communication controller 31 writes, into the memory device 33, the one or more new sets of job information received along with the second registration request signal (P18).

The communication controller 31 then executes an associated parameters initializing process (P19), which is described later. In the associated parameters initializing process, the communication controller 31 initializes various parameters associated with the new set of sequence information.

In response to completing the associated parameters initializing process, the communication controller 31 transmits a second registration completion signal to the terminal controller 101 (P20).

The user is thus able to visually recognize, on the external terminal 100, that all of the two or more sets of job information associated with the new set of sequence information are registered in the electric power tool 1.

2.4.1 Associated Parameters Initializing Process

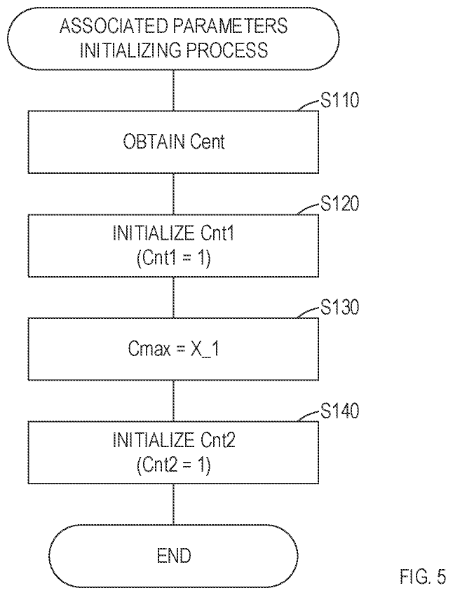

The communication controller 31 executes the associated parameters initializing process in the order exemplified in FIG. 5.

As shown in FIG. 5, the communication controller 31 obtains the entry count Cent from the new set of sequence information in S110 (S represents a step) and stores the obtained entry count Cent in the memory device 33. The entry count Cent corresponds to the number of N sets of job information to be selected in the semi-automatic mode, as mentioned above.

In the subsequent S120, the communication controller 31 initializes an entry counter Cnt1. The entry counter Cnt1 is a count variable (or count data) indicating an entry number. The entry number identifies the one set of job information selected in the semi-automatic mode. In the present embodiment, the communication controller 31 sets the entry counter Cnt1 (i.e. the entry number) to “I” in S120. The entry number set to “l” identifies the first set of job information (in other words, JOB_1) in the new set of sequence information.

In the subsequent S130, the communication controller 31 obtains the repeat count X_1 associated with the first set of job information from the new set of sequence information and sets the obtained repeat count X_1 to the maximum repeat count Cmax of the first set of job information.

In the next S140, the communication controller 31 initializes a repeat counter Cnt2. The repeat counter Cnt2 is a count variable (or count data) indicating the number of times that the selected one set of job information is selected. In the present embodiment, the communication controller 31 sets the repeat counter Cnt2 to “I” in S140.

After completing the initialization of the repeat counter Cnt2, the communication controller 31 ends the associated parameters initializing process.

2.4.2. Control Procedure in Semi-Automatic Mode

The following explains the procedure in which the communication circuit 13 causes the motor control circuit 12 to sequentially perform the tightening operations of the fasteners when the electric power tool is in the semi-automatic mode.

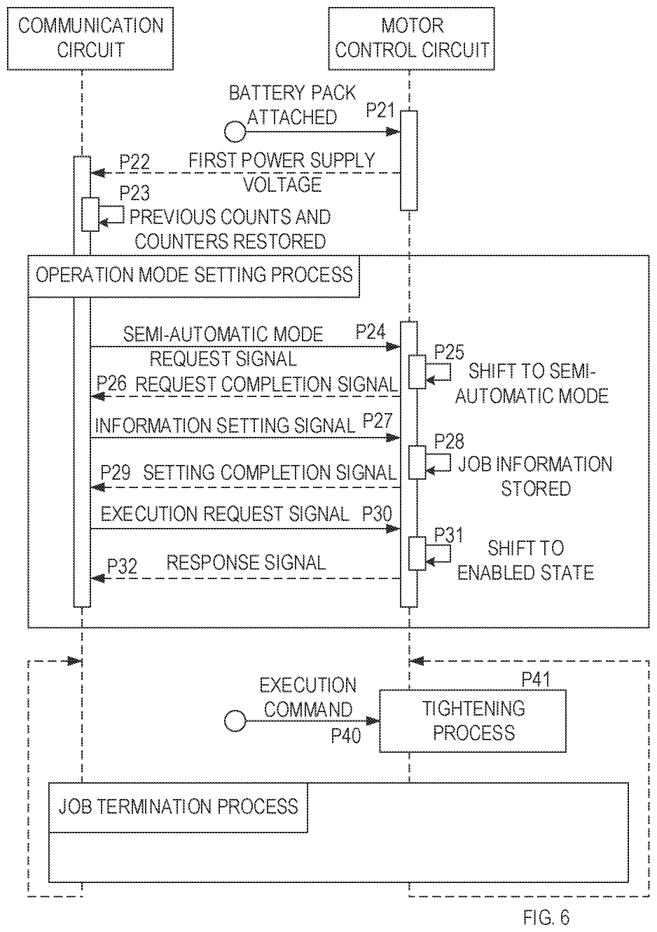

As shown in FIG. 6, in response to the battery pack 4 being attached to the battery port 2c, the first regulator 22 of the motor control circuit 12 starts generating the first power supply voltage which activates the motor controller 21 (P21).

The second regulator 32 of the communication circuit 13 then receives the first power supply voltage from the first regulator 22 (P21) and starts generating the second power supply voltage which activates the communication controller 31.

Since the electric power tool 1 is in the semi-automatic mode, the communication controller 31 restores the entry count Cent, the entry counter Cnt1, the maximum repeat count Cmax, and the repeat counter Cnt2 at the time in which the last operation of the communication controller 31 is terminated (P23).

An operation mode setting process is subsequently executed between the communication controller 31 and the motor controller 21.

In this operation mode setting process, the communication controller 31 first transmits a semi-automatic mode request signal to the motor controller 21 (P24). In response to receiving the semi-automatic mode request signal, the motor controller 21 changes its operation mode to the semi-automatic mode (P25) and transmits a request completion signal to the communication controller 31 (P26).

In response to receiving the request completion signal, the communication controller 31 reads out, from the memory device 33, one set of job information which corresponds to the restored entry counter Cnt1 and transmits the one set of job information to the motor controller 21 along with the information setting signal (P27). In response to receiving the information setting signal along with the one set of job information, the motor controller 21 stores the one set of job information in the RAM 21c (P28). The motor controller 21 then transmits a setting completion signal to the communication controller 31 (P29).

In response to receiving the setting completion signal, the communication controller 31 transmits an execution request signal to the motor controller 21 (P30). In response to receiving the execution request signal, the motor controller 21 changes its state from a disable state to an enabled state (P31). The motor controller 21 is in the disabled state when activated. The motor controller 21 then transmits a response signal to the communication controller 31 in response to the execution request signal (P32).

In the enabled state, the motor controller 21 waits for an execution command to be input to the motor controller 21 in response to the user pulling the trigger 5 for a tightening operation. In response to receiving the execution command (P40), the motor controller 21 executes a tightening process (P41). In the tightening process, the motor controller 21 drives the motor 11 in accordance with the at least one operation setting included in the one set of job information currently stored in the RAM 21c. As a consequence, the user is able to perform a tightening operation based on the selected one set of job information.

In response to the completion of the tightening process by the motor controller 21, a job termination process is initiated between the communication controller 31 and the motor controller 21.

In this job termination process, the communication controller 31 selects a next set of job information based on the one set of sequence information and sends the selected next set of job information to the motor controller 21. The motor controller 21 then stores the selected next set of job information in the RAM 21c.

As mentioned above, the motor controller 21 performs the tightening process two times or more based on the two or more sets of job information sequentially selected in accordance with the one set of sequence information. The job termination process is executed every time the motor controller 21 completes the tightening process.

In the present embodiment, when the motor controller 21 completes the tightening process two times or more in accordance with all of the two or more sets of job information defined in the one set of sequence information, the next set of job information to be provided to the motor controller 21 goes back to the first set of job information in the one set of sequence information and each of the two or more sets of job information defined in the one set of sequence information is repeatedly provided to the motor controller 21 in the same order.

2.4.3. Exemplary Procedure of Job Termination Process

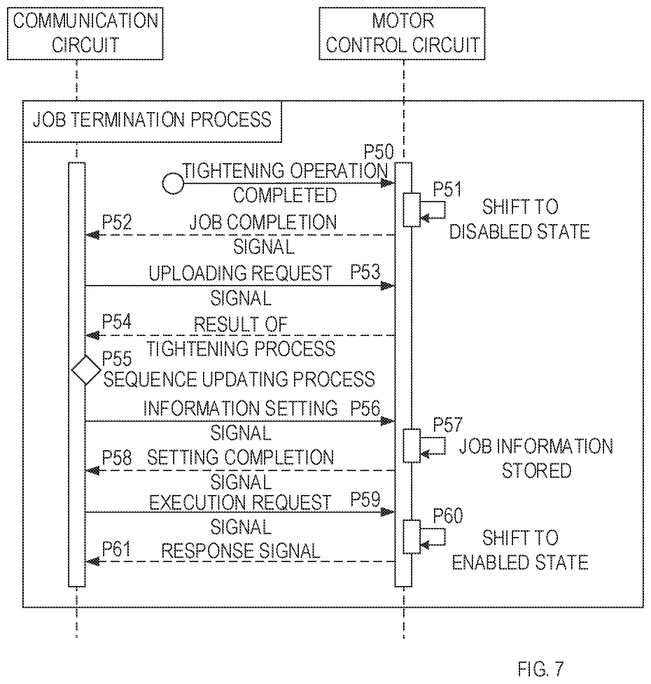

As shown in FIG. 7, in one example of the job termination process, when the completion of the tightening operation of a fastener is detected (P50), the motor controller 21 changes its state from the enabled state to the disabled state (P51). Subsequently, the motor controller 21 transmits a job completion signal to the communication controller 31 (P52).

In the present embodiment, the completion of the tightening operation is detected based on the torque detected by the torque sensor 16 having reached the desired tightening torque. In another embodiment, the completion of the tightening operation may be detected based on the magnitude of the electric current detected by the electric current detector 24, a time elapsed from the initiation of rotation of the motor 11, or an rotational angle of the motor 11.

In response to receiving the job completion signal, the communication controller 31 transmits an uploading request signal to the motor controller 21 (P53). Upon a receipt of the uploading request signal, the motor controller 21 transmits a result of the tightening process to the communication controller 31 (P54). Examples of the result includes the tightening torque detected, the magnitude of the electric current detected, the time required for the tightening operation, and variations in various parameters while the tightening process is executed.

In response to receiving the result of the tightening process, the communication controller 31 executes a sequence update process for executing the next tightening process based on the one set of sequence information (P55).

2.4.4. Details of Sequence Update Process

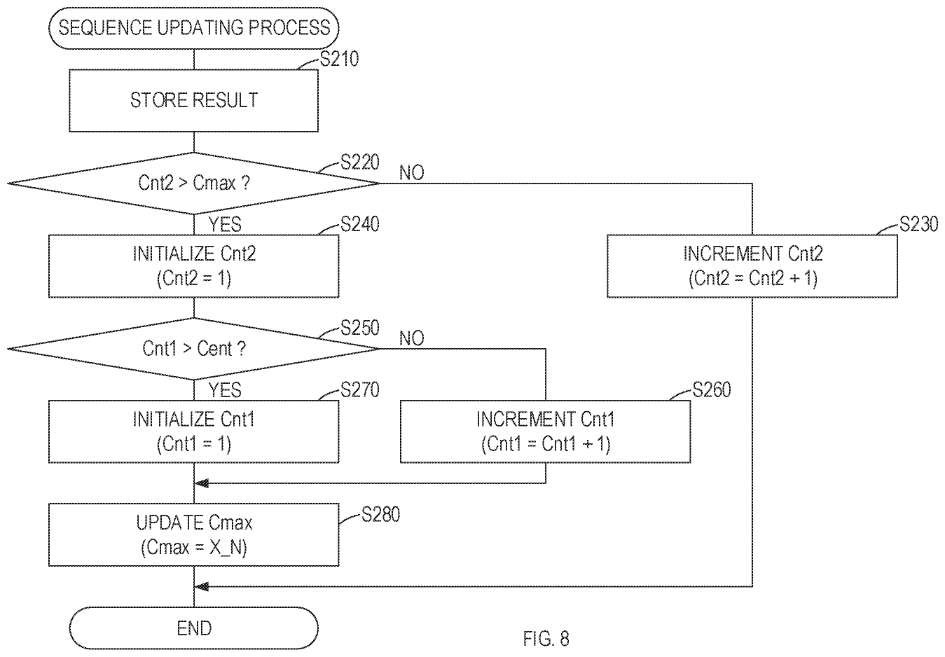

As shown in FIG. 8, in the sequence update process, the communication controller 31 stores the result of the current tightening process in the memory device 33 in S210. The communication controller 31 may store positional information of the electric power tool 1 in the memory device 33 along with the result of the current tightening process.

In the subsequent S220, the communication controller 31 determines whether the repeat counter Cnt2 exceeds the maximum repeat count Cmax. If the repeat counter Cnt2 is less than or equal to the maximum repeat count Cmax (S220: NO), the communication controller 31 proceeds to S230, increments the repeat counter Cnt2 (+1), and ends the sequence update process.

If the repeat counter Cnt2 exceeds the maximum repeat count Cmax (S220: YES), the communication controller 31 proceeds to S240 and initializes the repeat counter Cnt2 (that is, the communication controller 31 resets the repeat counter Cnt2 to “I”). In the subsequent S250, the communication controller 31 determines whether the entry counter Cnt1 exceeds the entry count Cent.

If the entry counter Cnt1 does not exceed the entry count Cent (S250: NO), the communication controller 31 proceeds to S260, increments the entry counter Cnt1 (+1), and proceeds to S280. If the entry counter Cnt1 exceeds the entry count Cent (S250: YES), the communication controller 31 proceeds to S270, initializes the entry counter Cnt1 (that is, the communication controller 31 resets the entry counter Cnt1 to “1”), and proceeds to S280.

S280 is executed immediately after the entry counter Cnt1 is updated in S260 or S270. Accordingly, in S280, the communication controller 31 sets the repeat count X_N, associated with the one set of job information corresponding to this entry counter Cnt1 (i.e. the entry number), to the maximum repeat count Cmax.

After the update of the maximum repeat count Cmax is completed, the communication controller 31 ends the sequence update process.

As shown in FIG. 7, the communication controller 31 executes the sequence update process by the procedure mentioned above and reads out, from the memory device 33, one set of job information corresponding to the entry counter Cnt1. The communication controller 31 then transmits the information setting signal to the motor controller 21 along with this one set of job information (P56).

In response to receiving the information setting signal along with the one set of job information, the motor controller 21 stores this one set of job information in the RAM 21c (P57). The motor controller 21 then transmits the setting completion signal to the communication controller 31 (P58).

In response to receiving the setting completion signal, the communication controller 31 transmits the execution request signal to the motor controller 21 (P59). In response to receiving the execution request signal, the motor controller 21 changes its state from the disabled state to the enabled state (P60) and transmits the response signal to the communication controller 31 (P61).

After changing to the enabled state, the motor controller 21 waits for the execution command to be input to the motor controller 21 from the trigger 5. In response to receiving the execution command, the motor controller 21 executes the aforementioned tightening process (P41) and drive the motor 11 in accordance with the at least one operation setting included in the one set of job information currently stored.

As mentioned above, the tightening process and the job termination process are repeatedly executed in order as shown in FIG. 6 and each of the two or more sets of job information is sequentially selected in the order defined in the one set of sequence information.

After completing the tightening process two times or more based on the sequence information, the first set of job information defined in the sequence information is selected once again, and the tightening process is repeatedly performed two times or more once again.

Accordingly, the electric power tool 1 of the present embodiment does not require to obtain one set of job information (i.e. at least one operation setting of the motor 11) from the external terminal 100 in every tightening operation, and therefore makes it possible to reduce the frequency of communication between the electric power tool 1 and the external terminal 100.

As a consequence, an increase in the processing load on the communication controller 31 can be inhibited. Furthermore, since it is not necessary to obtain and store the one set of job information for every communication, an increase in data stored in the electric power tool 1 can be inhibited.

In the electric power tool 1, the result of the tightening process is delivered from the motor controller 21 to the communication controller 31 every time the tightening process by the motor controller 21 ends. The communication controller 31 can store the result of the tightening process in the memory device 33 along with the positional information of the electric power tool 1.

Accordingly, the history of the results of the tightening process can be read out from the memory device 33 as necessary by an information processor, such as the external terminal 100. A person responsible for the electric power tool 1 can therefore easily manage job histories of the electric power tool 1 by using the information processor.

In addition, such responsible person can easily change two or more tightening operations repeatedly and sequentially performed in the semi-automatic mode by updating the one or more sets of sequence information and/or the one or more sets of job information. As a result, the electric power tool 1 can be more convenient to use.

2.5. Correspondence Between Terms

In the present embodiment, the trigger switch 17 corresponds to one example of the manual switch in Overview of Embodiments: the motor control circuit 12 corresponds to one example of the first circuit in Overview of Embodiments; the communication circuit 13 corresponds to one example of the second circuit in Overview of Embodiments; the torque sensor 16, rotation sensor 15, or the current detector 24 corresponds to one example of the sensor in Overview of Embodiments; the first wireless communicator 35 or the first wired communicator 36 corresponds to one example of the communicator in Overview of Embodiments; the external terminal 100 corresponds to one example of the external device in Overview of Embodiments; and the N repeat counts X_1 through X_N correspond to one example of the two or more parameters in Overview of Embodiments.

2.6. Variations

Although the example embodiment of the present disclosure have been explained above, the present disclosure may be implemented in various forms without being limited to the aforementioned example embodiment.

The two or more sets of job information and/or the two or more sets of sequence information may be set in the electric power tool 1 by the user via the input circuit 34.

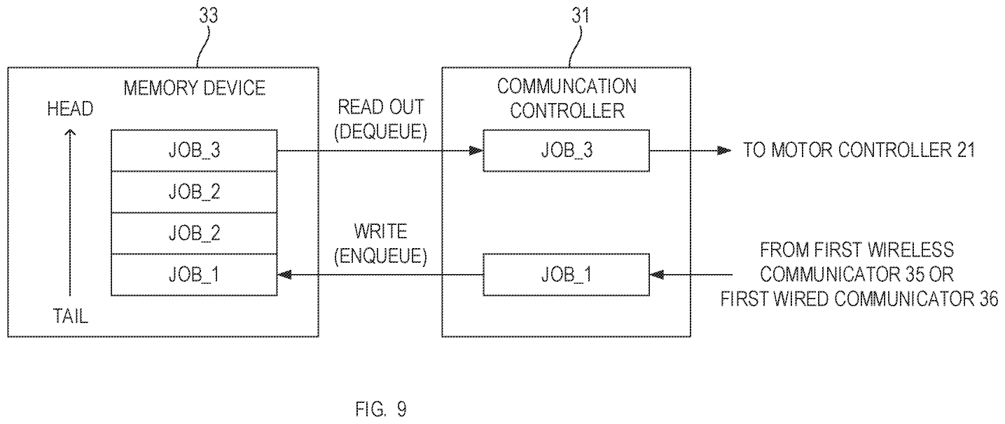

As shown in FIG. 9, the two or more sets of job information may be stored in the memory device 33 in the order they are selected. The two or more sets of job information may be read out from the memory device 33 in the order they are stored, and the motor 11 may be driven in accordance with the at least one operation setting included in the one set of job information thus read out. In this case, each of the two or more sets of job information can be sequentially selected without any one set of sequence information in the semi-automatic mode.

The motor control circuit 12 and the communication circuit 13 may be on a single circuit board. In this case, the motor controller 21 and the communication controller 31 may be implemented on a single microcomputer.

The trigger switch 17 may be configured such that its electrical resistance varies depending on a distance the trigger 5 is pulled, in addition to being turned ON and OFF. In this case, the maximum rotational speed of the motor 11 can be limited depending on the electrical resistance of the trigger switch 17 (in other words, the distance the trigger 5 is pulled).

Two or more functions achieved by one element in the aforementioned embodiments may be achieved by two or more elements, and one function achieved by one element may be achieved by two or more elements. In addition, two or more functions achieved by two or more elements may be achieved by one element, and one function achieved by two or more elements may be achieved by one element. A part of the configurations in the aforementioned embodiments may be omitted. Furthermore, at least a part of the configurations of the aforementioned embodiments may be added to or replaced with another part of the configurations of the aforementioned embodiments.

In addition to the aforementioned electric power tool 1, the present disclosure can be implemented in various forms such as in a system including the electric power tool 1, in a computer program for functioning a computer included in the electric power tool 1, in a non-transitory tangible storage medium such as a semiconductor memory that stores this computer program, and in a method of controlling the electric power tool 1.

What is claimed is:

1. An electric power tool comprising:
an output shaft (i) including a tip tool or (ii) configured to be detachably attached to the tip tool, the tip tool being configured to detachably engage with fasteners;
a motor configured to rotationally drive the output shaft;
a manual switch configured to be manually operated by a user of the electric power tool for driving the motor;
a memory device configured to store two or more sets of job information, the two or more sets of job information being associated with respective two or more tightening operations of the fasteners, each of the two or more sets of job information including at least one operation setting of the motor for performing an associated tightening operation;
a first circuit configured (i) to receive one set of job information and (ii) to drive the motor in accordance with the at least one operation setting included in the one set of job information based on the manual switch being or having been manually operated, the one set of job information corresponding to one of the two or more sets of job information stored in the memory device; and
a second circuit (i) distinct from the first circuit and (ii) configured to output a next set of job information in the two or more sets of job information from the memory device to the first circuit based on the first circuit having completed driving the motor, the next set of job information being associated with a next tightening operation in the two or more tightening operations.

2. The electric power tool according to claim 1, wherein:
the memory device is configured to store a set of sequence information;
the set of sequence information designates an order in which each of the two or more sets of job information is assigned to the next set of job information; and
the second circuit is configured to read out the next set of job information from the two or more sets of job information in the order designated by the set of sequence information stored in the memory device.

3. The electric power tool according to claim 2, wherein:
the set of sequence information includes two or more parameters associated with the respective two or more sets of job information, each of the two or more parameters defining a specified number of times to output an associated set of job information; and
the second circuit is configured to output the next set of job information to the first circuit in every completion of a drive of the motor by the first circuit until the second circuit completes outputs of the next set of job information for the specified number of times defined by an associated parameter.

4. The electric power tool according to claim 1,
wherein the second circuit is configured to read out the next set of job information from the two or more sets of job information in an order in which each of the two or more sets of job information is stored in the memory device.

5. The electric power tool according to claim 1, further comprising:
a sensor configured (i) to detect a result of a tightening operation performed and (ii) to output a detection signal, the detection signal indicating the result of the tightening operation performed, wherein:
the first circuit is configured (i) to receive the detection signal and (ii) to output, to the second circuit, the result indicated by the detection signal based on a completion of a drive of the motor; and
the second circuit is configured (i) to receive the result and (ii) to store the result in the memory device.

6. The electric power tool according to claim 1,
wherein the at least one operation setting includes a desired rotational speed of the motor, a desired tightening torque of a fastener, a desired operating time of the motor, a start-up profile of the motor, and/or a stop profile of the motor.

7. The electric power tool according to claim 1, further comprising:
a first regulator associated with the first circuit; and
a second regulator associated with the second circuit.

8. The electric power tool according to claim 7, wherein:
the first regulator is configured to generate a first voltage; and
the second regulator is configured (i) to receive the first voltage from the first regulator and (ii) to generate a second voltage based on the first voltage received.

9. The electric power tool according to claim 8,
wherein the first regulator is configured (i) to receive an electric power from a battery pack and (ii) to generate the first voltage based on the electric power received.

10. The electric power tool according to claim 8,
wherein the second voltage is different from the first voltage.

11. The electric power tool according to claim 1, further comprising:
a first circuit board including the first circuit thereon; and
a second circuit board (i) including the second circuit thereon and (ii) distinct from the first circuit board.

12. The electric power tool according to claim 11, further comprising
a connector electrically coupling the first circuit board to the second circuit board.

13. The electric power tool according to claim 11,
wherein the memory device is on the second circuit board.

14. The electric power tool according to claim 1,
wherein the memory device includes a rewritable and non-volatile memory.

15. The electric power tool according to claim 1, further comprising
a communicator configured to perform a wired communication or a wireless communication with an external device, wherein:
the external device is distinct from the electric power tool; and
the second circuit is configured (i) to receive the two or more sets of job information from the external device via the communicator and (ii) to store, in the memory device, the two or more sets of job information received.

16. The electric power tool according to claim 15,
wherein the second circuit includes the communicator.

17. The electric power tool according to claim 1,
wherein the second circuit includes the memory device.

18. The electric power tool according to claim 1, further comprising
a main body including the motor, the manual switch, the memory device, the first circuit, and the second circuit.

19. A method of tightening fasteners with an electric power tool, the method comprising:
storing two or more sets of job information in a memory device of the electric power tool, the two or more sets of job information being associated with respective two or more tightening operations of the fasteners, each of the two or more sets of job information including at least one operation setting of a motor of the electric power tool for performing an associated tightening operation;
receiving one set of job information by a first circuit of the electric power tool, the one set of job information corresponding to one of the two or more sets of job information stored in the memory device, the first circuit being configured to drive the motor in accordance with the at least one operation setting included in the one set of job information received;
driving the motor by the first circuit based on a manual switch of the electric power tool being or having been manually operated; and
outputting a next set of job information in the two or more sets of job information from the memory device to the first circuit by a second circuit of the electric power tool based on the first circuit having completed driving the motor, the second circuit being distinct from the first circuit, the next set of job information being associated with a next tightening operation in the two or more tightening operations.
